(19) United States
(12) Patent Application Publication
(10) Pub. No.: US 2009/0235309 A1
(43) Pub. Date: Sep. 17, 2009

(54) METHODS AND DEVICES FOR PRESENTING AN INTERACTIVE MEDIA GUIDANCE APPLICATION

(75) Inventor: Glen E. Roe, Simi Valley, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: United Video Properties, Inc., Los Angeles, CA (US)

(21) Appl. No.: 12/051,809

(22) Filed: Mar. 19, 2008

Related U.S. Application Data
(60) Provisional application No. 61/036,503, filed on Mar. 14, 2008.

(51) Int. Cl. H04N 5/445

(52) U.S. Cl. 725/39

(57) ABSTRACT

Methods and devices for presenting an interactive media guidance application are provided in accordance with various embodiments. In some embodiments, methods for presenting an interactive media guidance application are provided, the methods comprising: accessing guide listings from storage, wherein at least a portion of the guide listings have corresponding channel numbers and a relative ordering in the guide listings; accessing user channel preference information, wherein the user channel preference information specifies a station ordering based on at least one of a selection of a location and a selection of a media provider; and presenting the guide listings to a user based on the station ordering such that the at least a portion of the guide listings are presented with channel numbers different from the corresponding channel numbers and in an order different from the relative ordering.

This application claims the benefit of U.S. Provisional Application No. 61/036,503, filed Mar. 14, 2008, the disclosure of which is hereby incorporated by reference herein in its entirety.

### BACKGROUND OF THE INVENTION

Interactive television program guides are popular mechanisms through which television viewers can view and select from ever-increasing television programming choices. As the numbers of television stations have grown over the years, television viewers have become accustomed to learning the channel numbers of their favorite television stations. For example, a sports enthusiast may memorize all of the channel numbers of sports stations, while a music enthusiast may memorize all of the channel numbers of music stations. This enables those enthusiasts to easily and quickly find their favorite programs both in an interactive program guide (e.g., by manually selecting those channels in the guide) as well as with live television.

When television viewers are viewing television provided by a television provider (e.g., via broadcast or a cable, telephone-line-television, or satellite company) that is unfamiliar to them, finding their favorite programming can be difficult and frustrating because the channel numbers assigned to stations carrying those programs are frequently different. This may be the case when visiting family and friends, and when traveling and staying at a hotel or watching television on an airplane.

Accordingly, it is desirable to provide mechanisms which enable television viewers to more easily find television programs when using unfamiliar television providers.

### SUMMARY OF THE INVENTION

Methods and devices for presenting an interactive media guidance application are provided in accordance with various embodiments of the present invention. In some embodiments, methods for presenting an interactive media guidance application are provided, the methods comprising: accessing guide listings from storage, wherein at least a portion of the guide listings have corresponding channel numbers and a relative ordering in the guide listings; accessing user channel preference information, wherein the user channel preference information specifies a station ordering based on at least one of a selection of a location and a selection of a media provider; and presenting the guide listings to a user based on the station ordering such that at least a portion of the guide listings are presented with channel numbers different from the corresponding channel numbers and in an order different from the relative ordering.

In some embodiments, devices for presenting an interactive media guidance application are provided, the devices comprising: processing circuitry that: accesses guide listings from storage, wherein at least a portion of the guide listings have corresponding channel numbers and a relative ordering in the guide listings; accesses user channel preference information, wherein the user channel preference information specifies a station ordering based on at least one of a selection of a location and a selection of a media provider; and presents the guide listings to a user based on the station ordering such that at least a portion of the guide listings are presented with channel numbers different from the corresponding channel numbers and in an order different from the relative ordering.

In some embodiments, devices for presenting an interactive media guidance application are provided, the devices comprising: means for accessing guide listings from storage, wherein at least a portion of the guide listings have corresponding channel numbers and a relative ordering in the guide listings; means for accessing user channel preference information, wherein the user channel preference information specifies a station ordering based on at least one of a selection of a location and a selection of a media provider; and means for presenting the guide listings to a user based on the station ordering such that at least a portion of the guide listings are presented with channel numbers different from the corresponding channel numbers and in an order different from the relative ordering.

### BRIEF DESCRIPTION OF THE DRAWINGS

FIG. 1 illustrates an example of a grid display in an interactive media guidance application in accordance with some embodiments of the present invention.

FIG. 2 illustrates an example of a mosaic display in an interactive media guidance application in accordance with some embodiments of the present invention.

FIG. 3 illustrates an example of user equipment devices that may be used to implement an interactive media guidance application in accordance with some embodiments of the present invention.

FIG. 4 illustrates an example of a system for implementing an interactive media guidance application in accordance with some embodiments of the present invention.

FIG. 5 illustrates an example of a grid display in an interactive media guidance application in which stations have been re-ordered in accordance with some embodiments of the present invention.

FIG. 6 illustrates an example of a mosaic display in an interactive media guidance application in which stations have been re-ordered in accordance with some embodiments of the present invention.

FIG. 7 illustrates an example of a grid display in an interactive media guidance application containing a prompt for selecting a station ordering in accordance with some embodiments of the present invention.

FIG. 8 illustrates another example of a grid display in an interactive media guidance application containing a prompt for selecting a station ordering in accordance with some embodiments of the present invention.

FIG. 9 illustrates yet another example of a grid display in an interactive media guidance application containing a prompt for selecting a station ordering in accordance with some embodiments of the present invention.

FIG. 10 illustrates an example of a prompt for manually selecting a station ordering in accordance with some embodiments of the present invention.

FIG. 11 illustrates another example of a prompt for manually selecting a station ordering in accordance with some embodiments of the present invention.

FIG. 12 illustrates an example of a prompt for selecting a station ordering when making a hotel reservation in accordance with some embodiments of the present invention.

FIG. 13 illustrates an example of a grid display in an interactive media guidance application in which a skin has been applied in accordance with some embodiments of the present invention.

FIG. 14 illustrates an example of a grid display in an interactive media guidance application in which detailed location and station ordering information is presented, and in which missing, extra, and similar guide listings relative to a station ordering are identified, in accordance with some embodiments of the present invention.

FIG. 15 illustrates a process for ordering and numbering stations in an interactive media guidance application in accordance with some embodiments of the present invention.

### DETAILED DESCRIPTION OF VARIOUS EMBODIMENTS

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content (which may be referred to herein as “programs” or “programming”) including conventional television programming, as well as pay-per-view programs, on-demand programs (as in video-on-demand (VOD) systems), Internet content (e.g., streaming media, downloadable media, Webcasts, etc.), and other types of media or video content (any or all of which may be provided by media providers (e.g., television broadcasters, cable television providers, satellite television providers, Internet service providers, etc.) via traditional broadcast, cable, satellite, Internet, or any other suitable mechanism(s)). Guidance applications may also allow users to navigate among and locate content related to the video content including, for example, video clips, articles, advertisements, chat sessions, games, etc.

With the advent of the Internet, mobile computing, and high-speed wireless networks, users are accessing media on personal computers (PCs) and other devices on which they traditionally did not, such as hand-held computers, personal digital assistants (PDAs), mobile telephones, vehicle entertainment systems, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

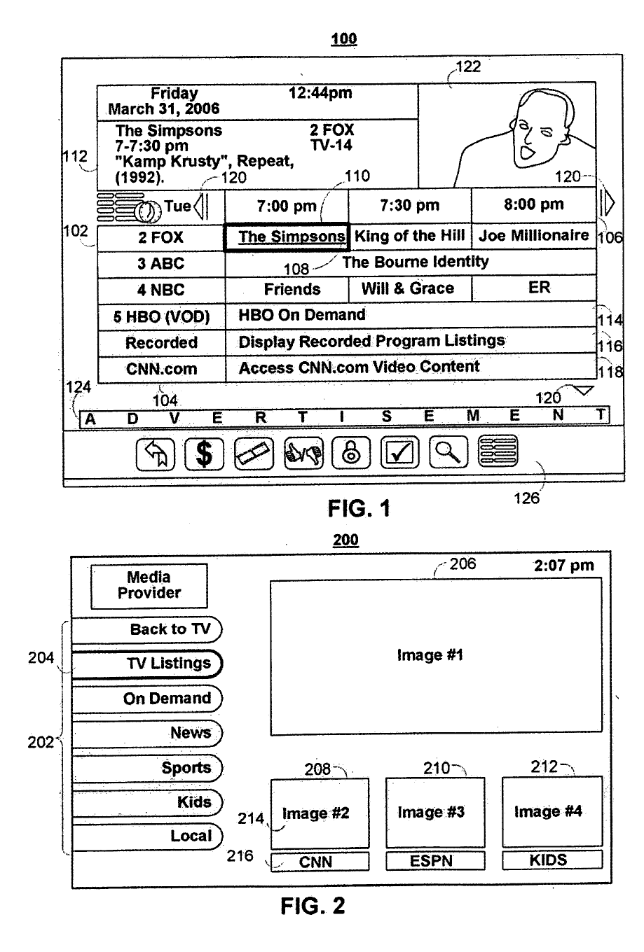

One of the functions of the media guidance application is to provide media listings and media information to users. FIGS. 1-2 show illustrative display screens that may be used to provide media guidance, and in particular media listings. The display screens shown in FIGS. 1-2 and 5-14 may be implemented on any suitable device or platform. While the displays of FIGS. 1-2 and 5-14 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, a media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

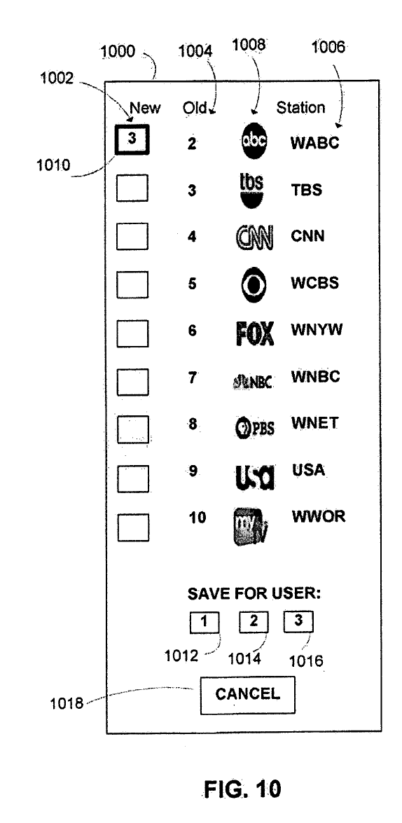

FIG. 1 shows illustrative grid program listings display 100 arranged by time and channel that enables access to different types of media content in a single display. Display 100 may include grid 102 with: (1) a column of channel/media type identifiers 104, where each channel/media type identifier (which is a cell in the column) identifies a different source of programming (which may also be referred to as a “station”); and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the station for the channel, the program's rating, and other desired information. The channel the program is on may be any suitable indicator and may be used as a mechanism for a user to identify the source of programming for the program (also referred to herein as a “station”). For example, this indicator may be a number (e.g., 123), may be one or more characters (e.g., WNBC), may be a logo (e.g., see reference numeral 1008 in FIG. 10), or may be any other suitable indicator. The indicator for a station may or may not correspond to a broadcast channel of the station. For example, the indicator for station WNBC in New York City (which is broadcast over the air, and on many cable television providers, on channel 4) may be a value other than 4 (e.g., 123).

In addition to providing access to linear programming provided according to a schedule, a media guidance application may also provide access to non-linear programming which is not provided according to a schedule. Non-linear programming may include content from different media sources including on-demand media content (e.g., video-on-demand (VOD)), Internet content (e.g., streaming media, downloadable media, etc.), locally stored media content (e.g., video content stored on a digital video recorder (DVR), digital video/versatile disc (DVD), video cassette, compact disc (CD), etc.), or other time-insensitive media content. On-demand content may include both movies and original media content provided by a particular source of programming (e.g., HBO On Demand providing “The Sopranos” and “Curb Your Enthusiasm”). HBO ON DEMAND, THE SOPRANOS, and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g., FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed may be based on user selection or guidance application definition (e.g., a display of only recorded and broadcast listings, only on-demand and broadcast listings, etc.), and any suitable permutation may be used. As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. Patent Application Publication No. 2003/0110499 A1, published Jun. 12, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting a program and/or channel as a favorite, purchasing a program, or other features. Options available from a main menu display may include search options, VOD options, parental control options, options to access various types of listing displays, options to subscribe to a premium service, options to edit a user's profile, options to access a browse overlay, or other options.

The media guidance application may be personalized based on a user's preferences. A personalized media guidance application may allow a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. Patent Application Publication No. 2005/0251827 A1, published Nov. 10, 2005, Boyer et al., U.S. Pat. No. 7,165,098, issued Jan. 16, 2007, and Ellis et al., U.S. Patent Application Publication No. 2002/0174430 A1, published Nov. 21, 2002, which are hereby incorporated by reference herein in their entireties. Collectively, the displays, features, user preferences, presentation schemes, aspects of media content listing displayed, desired recording features, parental controls, and/or desired customizations may be referred to as a “skin” to the media guidance application. In some embodiments, various options of skins may be provided to a user and/or customizable by a user.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. The listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are illustrated as being of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

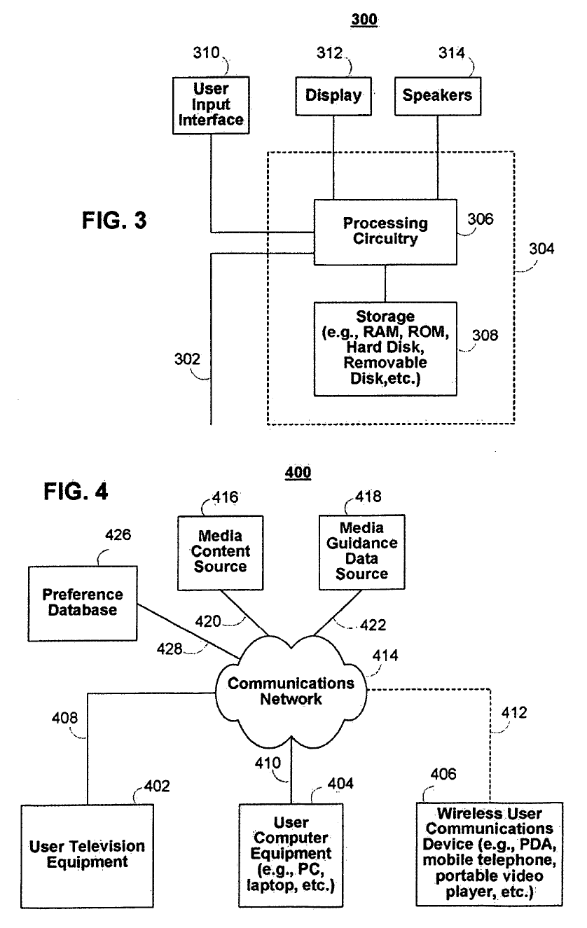

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, a wireless modem for communications with other equipment, a fiber-optic communications interface, a network interface (e.g., for an Ethernet network), and/or any other suitable interface. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Non-volatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV (now known as MSN TV) is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In addition to providing an interactive media guidance application, in some embodiments, some or all of user television equipment 402, user computer equipment 404, and/or wireless user communications device 406 can provide other functions. For example, these user equipment devices may provide navigation functions as part of an embedded or a portable navigation system. As a more particular example, an interactive media guidance application and a navigation system may be included in user equipment devices used on, or which are part of, an automobile, a motorcycle, a boat, a ship, an airplane, or other vehicle. As another more particular example, an interactive media guidance application and a navigation system may be included in user equipment devices which are also mobile telephones, portable entertainment devices (e.g., such as music or video players), portable email devices, etc.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to control, and/or maintain consistent media guidance application settings across, in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel may appear as a favorite on the user's in-home devices (e.g., user television equipment and user computer equipment) as well as the user's mobile devices, if desired. As another example, a user may specify using one device (e.g., a portable device or one mounted in the user's automobile) that a program is to be recorded on another of the user's devices (e.g., the user's home device). Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 may be coupled to communications network 414 via communications paths 408, 410, and 412, respectively. Communications network 414 may be one or more networks including the Internet, a mobile phone network, mobile device (e.g., Blackberry) network, cable network, public switched telephone network, a satellite network (e.g., a satellite television network, or other satellite communications network) or other types of communications network or combinations of communications networks. BLACKBERRY is a trademark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a trademark owned by Bluetooth SIG, INC. The user equipment devices may also communicate with each other directly through an indirect path via communications network 414.

System 400 includes media content source 416, media guidance data source 418, and preference database 426 coupled to communications network 414 via communication paths 420, 422, and 428, respectively. Paths 420, 422, and 428 may include any of the communication paths described above in connection with paths 408, 410, and 412. Communications with each of the media content source 416, media guidance data source 418, and preference database 428 may be exchanged over one or more communications paths, but are shown as a single path in FIG. 4 to avoid overcomplicating the drawing. In addition, there may be more than one of each of media content source 416, media guidance data source 418, and preference database 426, but only one of each is shown in FIG. 4 to avoid overcomplicating the drawing. (The different types of each of these mechanisms are discussed below.) If desired, two or more of media content source 416, media guidance data source 418, and preference database 426 may be integrated as one source device. Although communications between sources 416 and 418 and database 426 with user equipment devices 402, 404, and 406 are shown as through communications network 414, in some embodiments, sources 416 and 418 and database 426 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, telephone company television providers, or other providers of media content, which may control the distribution equipment, and the distribution functions of, media content source 416. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. Patent Application Publication No. 2003/0149988 A1, published Aug. 7, 2003, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections. Broadcast channels and logo data may be used to indicate an over-the-air channel number, a call sign (or call letters), a logo, etc. associated with a broadcaster or station.

Preference database 426 may be a database for storing, for one or more guidance applications, any suitable data relating to skins, displays and features which create a personalized “experience,” presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and/or any other desired customizations. Preference database 426 may be implemented in any suitable hardware and/or software, such as a server on the Internet (for example), and may be implemented using any suitable data storage technique.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Application Publication No. 2005/0251827 A1, published Nov. 10, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access a media guidance application on a website via a personal computer at their office, on a mobile device such as a PDA or web-enabled mobile telephone, on a vehicle-based system that is part of or coupled to a navigation system, etc. The user may set various settings (e.g., recordings, reminders, or other settings) on the guidance application to control the user's in-home equipment. The guide may control the user's equipment directly, or by communicating with a media guidance application on the user's in-home equipment. Various systems and methods for user equipment devices communicating, where the user equipment devices are in locations remote from each other, are discussed in, for example, Ellis et al., U.S. Patent Application Publication No. 2005/0028208 A1, published Feb. 3, 2005, which is hereby incorporated by reference herein in its entirety.

In a third approach, users of user equipment devices inside and outside a home can use their media guidance application to communicate directly with media content source 416 to access media content. Specifically, within a home, users of user television equipment 402 and user computer equipment 404 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

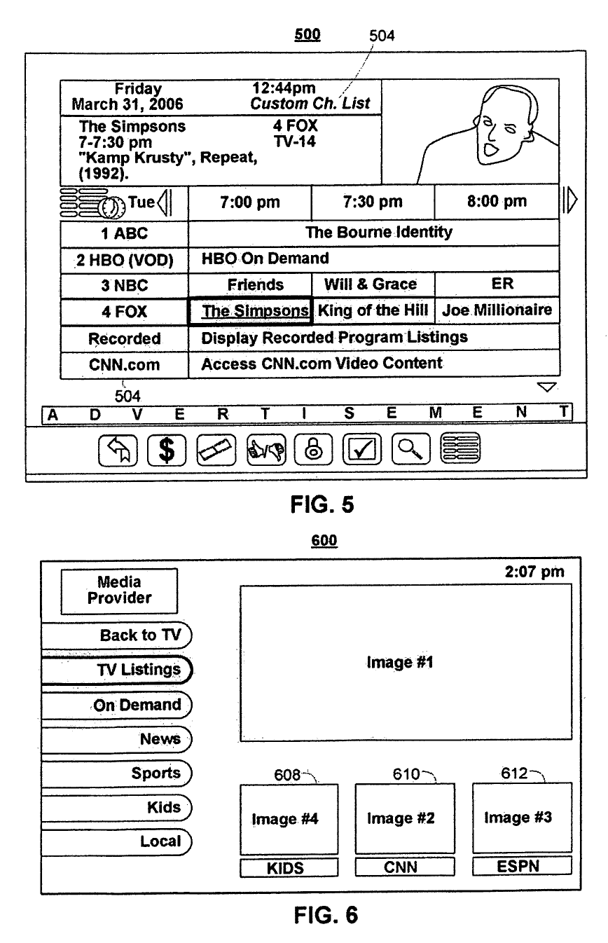

In some embodiments of the present invention, a user of an interactive media guidance application may be able to re-order and/or re-number the stations, and corresponding program information, presented in the guidance application. A user may want to do this to conform the order and/or numbers of the stations to a custom arrangement organized as the user desires, to that of another content distributor (e.g., a particular cable or satellite television provider) having an order and/or numbers that the user is familiar with, or to any other desired arrangement. For example, a user may receive stations of programming by default in the arrangement shown in FIG. 1. As illustrated, FOX is on channel 2, ABC is on channel 3, NBC is on channel 4, and HBO (VOD) is on channel 5. FOX is trademark owned by Fox Broadcasting Company. After re-ordering and/or re-numbering the stations as illustrated in channel identifiers 504 of application 500 of FIG. 5, for example, these stations may be ordered so that ABC is on channel 1, HBO (VOD) is on channel 2, NBC is on channel 3, and FOX is on channel 4. Any suitable re-ordering and/or re-numbering of stations may be implemented, and any portion of the stations may be re-ordered and/or re-numbered. As also shown in FIG. 5, an indicator 504 may be provided to reflect that the stations have been re-ordered and/or re-numbered.

As used herein, the term “numbering” may include only numbers, may include numbers and/or characters, or may include any suitable numbers, characters, and/or symbols that may be used to identify stations. For example, a numbering of channels may be 2, 3, 4, etc., may be A, B, C, D, etc., may be #, @, %, etc., or may be any combination or sub-combination of these.

As illustrated in FIG. 6, a video mosaic display 600 may also be re-ordered as compared to FIG. 2. As shown, rather than image 2 for CNN appearing in the left-most listing 208, image 2 for CNN may appear in the center listing 610. Similarly, image 3 for ESPN may appear in the right-most listing 612 rather than center listing 210, and image 4 for KIDS may appear in the left-most listing 608 rather than right-most listing 212. CNN is a trademark owned by Cable News Network. ESPN is a trademark owned by ESPN Inc.

Any suitable interface may be used to enable a user to select the order and/or numbering of sources of programming. The re-ordering and/or re-numbering may be based on the ordering and/or numbering of a specified media provider, may be based on manual user selections, may be based on pre-defined settings, and/or any other suitable ordering and/or numbering.

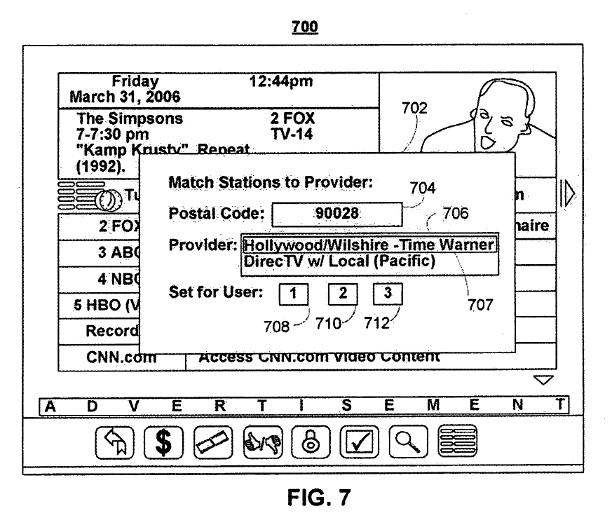

FIG. 7 is an illustration of one example of an interface 700 for enabling a user to select to re-order and/or re-number stations to channel numbers of a specified media provider. As shown, interface 700 includes a window 702 which prompts the user to enter a postal code (or ZIP code) in field 704. Upon entering the postal code (e.g., using number buttons on a remote control), a provider field 706 may be updated to show various media providers known to service the location corresponding to the postal code. The user may then select one of the providers listed in field 706 by repositioning a highlight region 707 using a cursor control on a remote control. Next, by pressing one of buttons 1, 2, or 3, corresponding to users of the guidance application, a user can save the settings for that user as indicated by icons 708, 710, and 712.

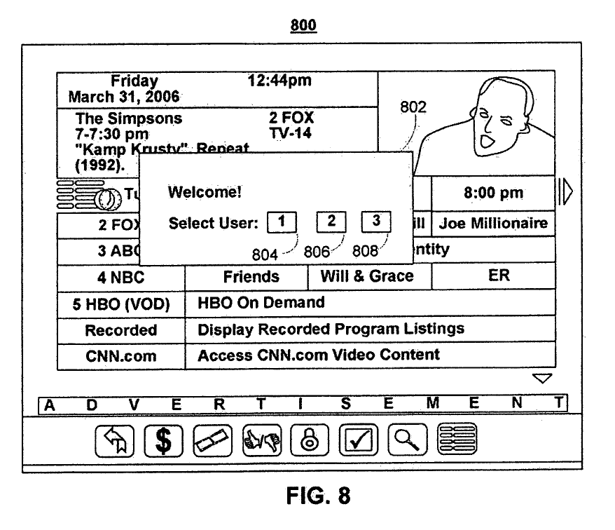

As shown in FIG. 8, after a selection of station re-ordering and/or re-numbering has been selected by a user, upon re-activating a guidance application, a user can select which configuration of ordering and/or numbering to view by selecting a user from a user selection window 802. Upon seeing this window, the user may be prompted to press one of buttons 1, 2, and 3 on the user's remote control by icons 804, 806, and 808, which may then cause the ordering and/or numbering of the stations, and any other desired preferences, to appear as configured for the user. In some embodiments, window 802 may only be presented upon a user selecting a menu option or pressing a specified button on a remote control.

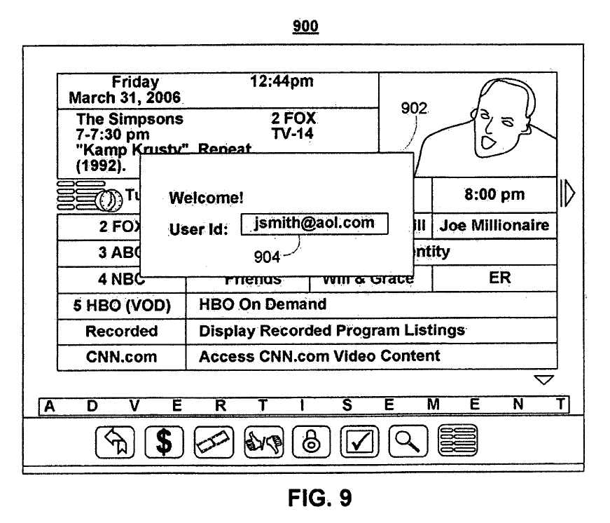

As shown in FIG. 9, in some embodiments, a user may alternatively enter a user identification to specify the ordering and/or numbering of stations to be used. For example, the user may enter an email address of the user into a field 904 in a window 902. Although an email address is illustrated here as a user identification, a suitable combination of numbers, letters, and/or other characters may be used.

FIG. 10 illustrates an example of another mechanism for specifying the ordering and/or numbering of stations. As shown, a window 1000 may include a list of new channel numbers 1002, a list of old channel numbers 1004, a list of stations 1006, and a list of icons for the stations 1008. The old channel numbers may indicate the channel numbers assigned to stations prior to any change by the user. By highlighting a field for a new channel number in a field in list 1002 with a highlight region 1010 using arrows on a remote control, a user can then press number buttons on the remote control to enter a new channel number for the corresponding station. Once a user has completed entering new channel numbers, the user can select one of icons 1012, 1014, and 1016 to save the changes for a given user 1, 2, or 3 of the guidance application, or cancel the changes by selecting cancel button 1018.

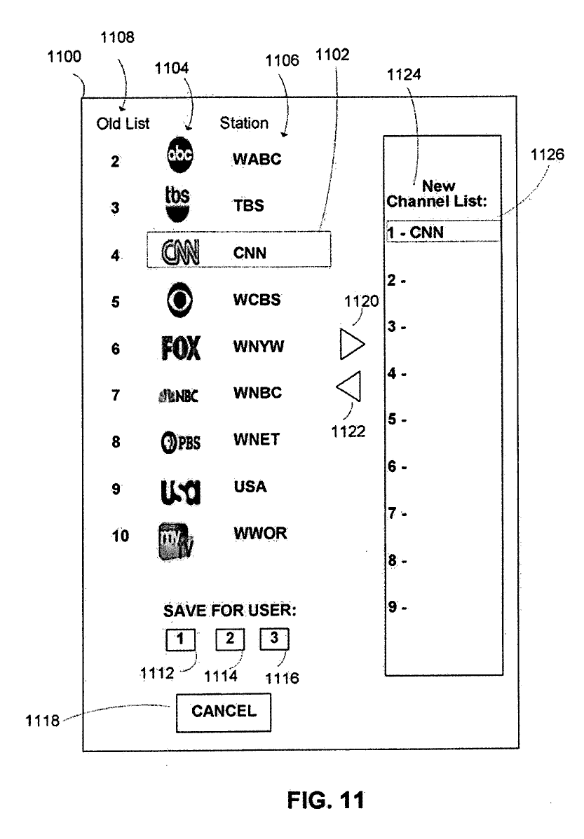

FIG. 11 illustrates another example of a mechanism for specifying the ordering and/or numbering of stations. As shown, a window 1100 may include an old list of channel numbers 1108, a new list of channel numbers 1124, a list of stations 1106, a list of icons 1104, a station highlight region 1102, a new channel number highlight region 1126, an add-to-list button 1120, and a remove-from-list button 1122. To add a station to the new channel list 1106, a user may position region 1102 on a desired station, position region 1126 on a desired position in list in 1124, and select add-to-list button 1120. To remove a station from the new channel list 1106, a user may position region 1126 on the station in list 1106 and select remove-from-list button 1122. Once the user has configure the new channel list as desired, the user can select one of icons 1112, 1114, and 1116 to save the new channel list for one of users 1, 2, or 3. Alternatively, the user can cancel the changes by selecting cancel button 1118.

In some embodiments, a user can configure the ordering and/or numbering of stations to be presented in a guidance application in a hotel room they are or will be staying at, in an airplane or train they are or will be traveling on, etc. This may enable the user to interact with the guidance application in that environment in a similar or the same manner as the user does at home. In order to select the ordering and/or numbering of stations when they are in a hotel room, on an airplane, etc., the user can select a media provider ordering and/or numbering as illustrated in, and described in connection with, FIG. 7, or select a stored configuration of ordering and/or numbering by providing a user identification as illustrated in, and described in connection with, FIG. 9. The appropriate ordering and/or numbering may then be retrieved by the guidance application being presented in the hotel, airplane, etc., and the ordering and/or numbering may be used.

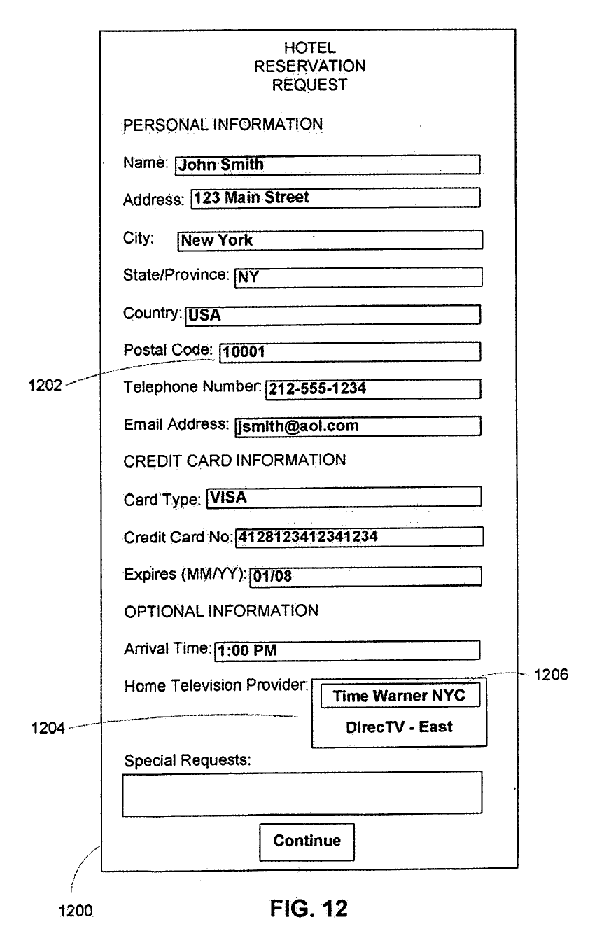

A user may also configure an ordering and/or numbering to be presented in a guidance application in advance of being in the environment of a hotel, airplane, etc. For example, as illustrated in the example of FIG. 12, a user may specify the user's home television provider when requesting a reservation at a hotel. More particularly, for example, when creating a reservation at a hotel on the hotel's Web site, a user may be presented with a request page 1200. In addition to the other information shown, the page may prompt the user for a postal code 1202. Once entered, the page may automatically update the list of providers known to service that location (e.g., via broadcast, satellite, cable, telephone lines, etc.) in a home television provider field 1204. The user may then select a provider using a highlight region 1206 and then continue with the registration process. The Web server of the hotel, airplane, etc. can then transfer this information to a preference database (e.g., database 426 of FIG. 4) which may then automatically be used to update the ordering and/or numbering of stations for the user when he/she arrives in the environment.

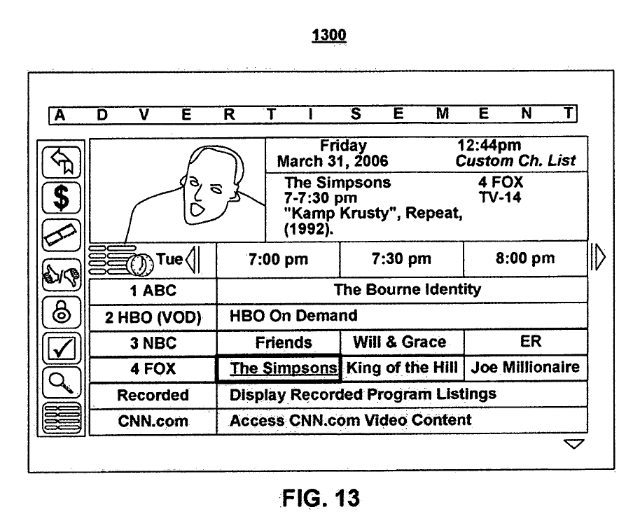

In some embodiments, as shown in FIG. 13, a user may be able to customize a skin of the guidance application. As illustrated, this skin may be modified by relocating items presented in the guidance application, by changing fonts, by changing decorative graphics, by changing colors, etc. When a user selects a station ordering and/or numbering as described above, the skin associated with the guidance application may also be changed to reflect a desired skin of the user and/or media provider that is familiar to the user.

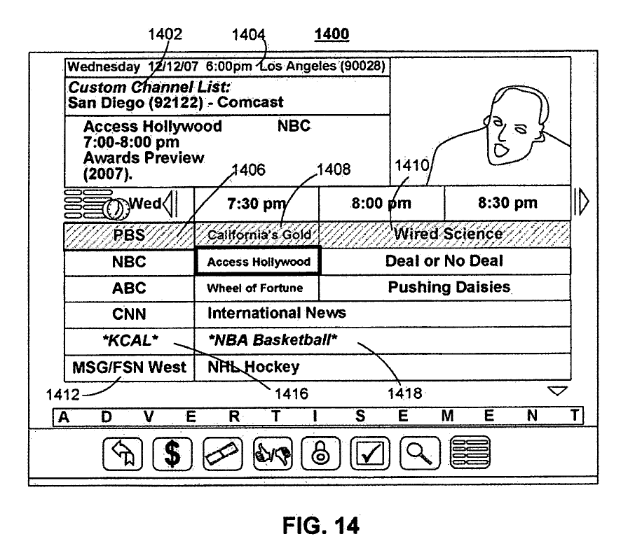

In some embodiments, a guidance application may provide additional details about the re-ordering and/or re-numbering of stations over that shown in FIG. 5. For example as shown in FIG. 14, a guidance application may present in a field 1404 the location (which may include a city and/or postal code) of the user and may present in a field 1402 the location of a media provider (which may include a city and/or postal code), and/or the provider's name, on which a displayed station ordering is based. In some embodiments, the provider may be specified by a provider name, a provider feed, a time zone, a programming package (e.g., a gold package, sports-package, local channels, etc.), and/or any other suitable characteristics.

In some instances, the ordering and/or numbering of stations selected by a user may not contain the same stations as that contained in the programming data to be presented in the guidance application. This may be the case because the stations in the selected ordering and/or numbering are different from the stations available in the local media provider, even though those stations may be related. For example, if a selected ordering and/or numbering contains an entry for station WNBC, a local media provider may not provide WNBC even though it provides station KNBC, which is a related station. In re-ordering and/or re-numbering stations, the guidance application may automatically associate local stations with stations in the selected ordering and/or numbering based on network affiliations (e.g., associating WNBC and KNBC), based on a type of channel (e.g., regional sports channels (such as MSG and FSN West, as illustrated in cell 1412), local news or weather channels, public access channels, music channels, foreign language channels, etc.), based on company relationships (e.g., CNN and Headline News), and/or based on any other suitable relationship.

The stations in the programming data may also be different from those in the selected ordering and/or numbering because the local media provider provides extra stations that are not included in the ordering and/or numbering selected by the user, or because the local media provider does not provide stations that are included in the ordering and/or numbering selected by the user. When stations are not provided by the local media provider, program listings for the station in the selected ordering and/or numbering may be presented in any suitable manner to indicate this status. For example, as illustrated in FIG. 14, cells 1406, 1408, and 1410 may be grayed-out to reflect that there is no local PBS station provided by the local media provider. Because there is no local programming information to present, cells 1406 and 1408 may instead present what content is available in a media provider selected as the basis for the ordering and/or numbering, may present an indicator that no program listings apply, or may present any other suitable information or message.

When stations are provided by the local media provider that are not included in a selected numbering and/or ordering, the stations may be presented in a manner to indicate this status, or may be omitted from the guidance application. For example, as shown in cells 1416 and 1418 the channel identifier and program listings for such stations may be highlighted (e.g., as shown here with asterisks). As another example, the program listings for such stations may be presented in a designated range of channel numbers. As yet another example, the program listings for such stations may be omitted from the guidance application. Any other suitable manner for presenting or omitting such stations may be used in various embodiments.

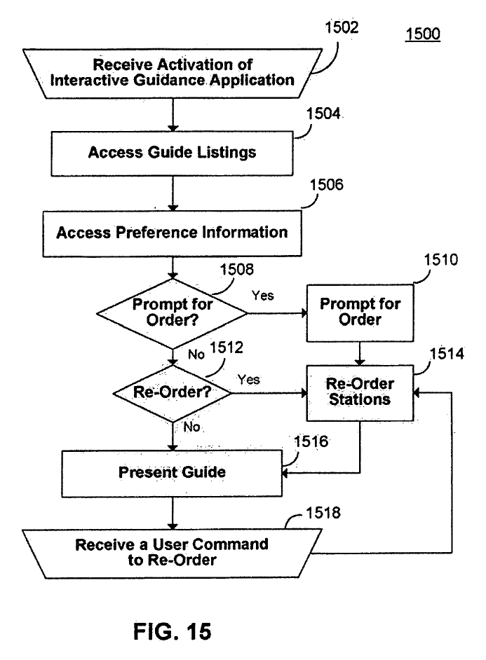

An example of a process 1500 for implementing re-ordering and/or re-numbering of stations in a guidance application in accordance with some embodiments is shown in FIG. 15. As illustrated, at 1502, the process may begin upon receiving an activation of the interactive program guide. This activation may occur, for example, by a user turning on a television, set-top box, or other device, by an automatic start-up mechanism, etc. Guide listings may then be accessed by the process at 1504. These listings may be retrieved from local memory, from a media guidance data source 418 (FIG. 4), or from any other suitable location. Preference information may next be accessed by the process at 1506. This preference information may be retrieved from local memory, from a preference database 426 (FIG. 4), or from any other suitable location. Next, at 1508, process 1500 may determine whether to prompt the user to select an ordering and/or numbering of the stations. If it is determined that a prompt is to be presented, process 1500 may present the prompt at 1510. For example, process 1500 may present prompts as illustrated in any of FIGS. 7-11, or may present any other suitable prompts. If it is determined at 1508 that a prompt is not to be presented, process 1500 may then determine at 1512 whether to re-order and/or re-number the stations. This determination may be based on any suitable information, such as preference information, a previous setting entered by a user (e.g., as illustrated in FIG. 12), etc. If it is determined at 1512 that the stations are to be re-ordered and/or re-numbered, or after prompting for an order at 1510, the stations may be re-ordered and/or re-numbered at 1514. This re-ordering and/or re-numbering may be performed in any suitable manner, such as that described above for example. After re-ordering and/or re-numbering the stations at 1514, or if it is determined at 1512 that re-ordering and/or re-numbering is not to be performed, a guide may be presented at 1516. This guide may be presented in any suitable manner, such as described above for example. If a command to re-order and/or re-number the stations is subsequently received at 1518, then process 1500 may loop back to 1514.

Thus, it is seen that methods and systems for presenting a guidance application are provided. For example, in some embodiments, methods and systems are provided that enable a television user that is away from a known environment (e.g., such as the user's home) to have the same experience as the user would in that environment, and/or that present a channel line-up that is the same or similar to that which would be presented in that environment. In addition to providing channel line-up information with which the user is familiar, embodiments of the present invention may also permit the user to perform channel navigation (e.g., channel up/down) in a similar channel ordering scheme. The channel ordering may be persistent, temporary, and also may be selected to revert back to the default order and/or numbering scheme at the user's present location.

One skilled in the art will appreciate that the invention can be practiced by other than the described embodiments, which are presented for purposes of illustration and not of limitation, that various features of the described embodiments can be interchanged and used in any suitable combination, and that the present invention is limited only by the claims which follow.

What is claimed is:

1. A method for presenting an interactive media guidance application, comprising:
accessing guide listings from storage, wherein at least a portion of the guide listings have corresponding channel numbers and a relative ordering in the guide listings;
accessing user channel preference information, wherein the user channel preference information specifies a station ordering based on at least one of a selection of a location and a selection of a media provider; and
presenting the guide listings to a user based on the station ordering such that the at least a portion of the guide listings are presented with channel numbers different from the corresponding channel numbers and in an order different from the relative ordering.

2. The method of claim 1, wherein the user channel preference information is based upon a travel reservation.

3. The method of claim 1, wherein the user channel preference information includes a zip code of the user.

4. The method of claim 1, wherein the station ordering is based on a selection of a location by the user.

5. The method of claim 1, wherein the station ordering is based on a selection of a media provider by the user.

6. The method of claim 5, wherein the selection of the media provider includes a selection of at least one of a feed, a time zone, and a provider programming package for the media provider.

7. The method of claim 1, wherein the station ordering includes a mapping of stations to channel numbers.

8. The method of claim 1, further comprising presenting the guide listings using a skin based on the user channel preference information.

9. The method of claim 1, further comprising identifying a station in the station ordering for which a guide listing is not available in the guide listings.

10. The method of claim 9, wherein an identifier corresponding to the station is grayed-out in the guide listings presented.

11. The method of claim 1, further comprising identifying in the guide listings presented a station that is not associated with any station in the station ordering.

12. The method of claim 1, further comprising associating a station in the station ordering to a portion of the guide listings by comparing a characteristic of the station to a characteristic of the guide listings.

13. The method of claim 1, wherein the interactive media guidance application is an interactive program guide.

14. A device for presenting an interactive media guidance application, comprising:
processing circuitry that:
accesses guide listings from storage, wherein at least a portion of the guide listings have corresponding channel numbers and a relative ordering in the guide listings;
accesses user channel preference information, wherein the user channel preference information specifies a station ordering based on at least one of a selection of a location and a selection of a media provider; and
presents the guide listings to a user based on the station ordering such that the at least a portion of the guide listings are presented with channel numbers different from the corresponding channel numbers and in an order different from the relative ordering.

15. The device of claim 14, wherein the user channel preference information is based upon a travel reservation.

16. The device of claim 14, wherein the user channel preference information includes a zip code of the user.

17. The device of claim 14, wherein the station ordering is based on a selection of a location by the user.

18. The device of claim 14, wherein the station ordering is based on a selection of a media provider by the user.

19. The device of claim 18, wherein the selection of the media provider includes a selection of at least one of a feed, a time zone, and a provider programming package for the media provider.

20. The device of claim 14, wherein the station ordering includes a mapping of stations to channel numbers.

21. The device of claim 14, wherein the processing circuitry also presents the guide listings using a skin based on the user channel preference information.

22. The device of claim 14, wherein the processing circuitry also identifies a station in the station ordering for which a guide listing is not available in the guide listings.

23. The device of claim 22, wherein an identifier corresponding to the station is grayed-out in the guide listings presented.

24. The device of claim 14, wherein the processing circuitry also identifies in the guide listings presented a station that is not associated with any station in the station ordering.

25. The device of claim 14, wherein the processing circuitry also associates a station in the station ordering to a portion of the guide listings by comparing a characteristic of the station to a characteristic of the guide listings.

26. The device of claim 14, wherein the interactive media guidance application is an interactive program guide.

27. A device for presenting an interactive media guidance application, comprising:
means for accessing guide listings from storage, wherein at least a portion of the guide listings have corresponding channel numbers and a relative ordering in the guide listings;
means for accessing user channel preference information, wherein the user channel preference information specifies a station ordering based on at least one of a selection of a location and a selection of a media provider; and
means for presenting the guide listings to a user based on the station ordering such that the at least a portion of the guide listings are presented with channel numbers different from the corresponding channel numbers and in an order different from the relative ordering.

28. The device of claim 27, wherein the user channel preference information is based upon a travel reservation.

29. The device of claim 27, wherein the user channel preference information includes a zip code of the user.

30. The device of claim 27, wherein the station ordering is based on a selection of a location by the user.

31. The device of claim 27, wherein the station ordering is based on a selection of a media provider by the user.

32. The device of claim 31, wherein the selection of the media provider includes a selection of at least one of a feed, a time zone, and a provider programming package for the media provider.

33. The device of claim 27, wherein the station ordering includes a mapping of stations to channel numbers.

34. The device of claim 27, further comprising means for presenting the guide listings using a skin based on the user channel preference information.

35. The device of claim 27, further comprising means for identifying a station in the station ordering for which a guide listing is not available in the guide listings.

36. The device of claim 35, wherein an identifier corresponding to the station is grayed-out in the guide listings presented.

37. The device of claim 27, further comprising means for identifying in the guide listings presented a station that is not associated with any station in the station ordering.

38. The device of claim 27, further comprising means for associating a station in the station ordering to a portion of the guide listings by comparing a characteristic of the station to a characteristic of the guide listings.

39. The device of claim 27, wherein the interactive media guidance application is an interactive program guide.
